(19) United States
(12) Patent Application Publication
(10) Pub. No.: US 2005/0128393 A1
(43) Pub. Date: Jun. 16, 2005

(54) Optical film, method for producing the same, and image display

(76) Inventors: Shuuji Yano, Osaka (JP); Hiroe Maeda, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/760,546

(22) Filed: Jan. 21, 2004

(30) Foreign Application Priority Data
Jan. 23, 2003 (JP) 2003-14757

(51) Int. Cl. G02F 1/1335

(52) U.S. Cl. 349/118

(57) ABSTRACT

Birefringence of a protective film and leakage of light in a cross-Nicole arrangement of polarizing plates may be canceled, when, as a polarizing plate protective film, using an optical film having an optical compensation layer (2) showing refractive index anisotropy satisfying a relationship of nx₂≈ny₂>nz₂, when a direction where an in-plane refractive index gives a maximum is defined as X-axis, a direction perpendicular to X-axis as Y-axis, a thickness direction as Z-axis, and when refractive indexes in each axial direction are defined as nx₂, ny₂, and nz₂, respectively, on one side of a base material film (1) in which each of refractive index differences represented with |nx₁−ny₁|, |nx₁−nz₁| and |nz₁−ny₁| has values of not more than 0.0006, respectively, when a direction where a refractive index in a film plane gives a maximum is defined as X-axis, a direction perpendicular to X-axis as Y-axis, a thickness direction of the film as Z-axis, and when refractive indexes in each axial direction are defined as nx₁, ny₁ and nz₁, respectively.

### BACKGROUND OF THE INVENTION

1. Field of the Invention

The present invention relates to an optical film. The optical film of the present invention may be used as various optical films, such as retardation plates, viewing angle compensation films, optical compensation films, elliptically polarizing plates and brightness enhanced films independently or in combination with other optical films. The present invention also relates to an image display using the optical film, such as liquid crystal displays, organic electro luminescence displays, and PDPs. Especially the optical film of the present invention is useful when using as a broadband polarizing plate with a polarizer laminated thereon. The elliptically polarizing plate concerned is effective especially in respect of contrast of liquid crystal displays in VA mode.

2. Description of the Prior Art

Conventionally, in liquid crystal displays, so-called TN mode are mainly used in which liquid crystal having positive dielectric anisotropy is horizontally oriented between mutually facing substrates. However, in TN mode, even if black display is required, a liquid crystal molecule in the vicinity of the substrate caused birefringence owing to driving characteristics thereof. And, in TN mode, the resulting optical leakage made it difficult to give perfect display of black color. On the other hand, in VA mode, since liquid crystal molecules have almost vertical orientation with respect to a substrate surface in non-driven state, a light passes through the liquid crystal layer, without giving almost any change to a polarization plane thereof. And as a result, in VA mode arrangement of polarizing plates on upper and lower sides of the substrate enables almost perfect black display in non-driven state.

Although almost perfect black display may be given in a direction of a normal to a panel in VA mode, leakage of light is observed based on influence of birefringence of the liquid crystal layer in observation of the panel in a direction shifted from the normal. And leakage of light also occurs based on influenced of birefringence of a protective film used for the polarizing plate. Consequently, there was a problem that viewing angle became narrower. In order to solve this problem, for the purpose of compensation of birefringence of a liquid crystal layer caused in observation of a panel from a diagonal direction, a technique that disposes a retardation plate having refractive index anisotropy satisfying a relationship of nx≈ny>nz at least on one side between the liquid crystal layer and the polarizing plate is disclosed (for example, refer to Japanese Patent Laid-Open No. 62-210423 official report).

However, even if birefringence of the liquid crystal layer is compensated in this way, leakage of light caused by the protective film of the polarizing plate occurs based on characteristics of a polarizing plate in a cross-Nicole arrangement, and also in a direction shifted from an optical axis of the polarizing plate, leading to problems of occurrence of lowering of contrast.

### SUMMARY OF THE INVENTION

The present invention aims at providing an optical film obtained by forming an optical compensation layer on a base material film, wherein the optical film concerned can overcome birefringence of the protective film, and leakage of light in a direction shifted from an optical axis in a cross-Nicole arrangement of the polarizing plate, when the base material film of the optical film is used as a protective film for a polarizing plate, and also a method for producing the same.

Furthermore, the present invention aims at providing an image display in which the above-mentioned optical film is laminated.

As a result of wholehearted research performed by the present inventors in order to solve the above-mentioned problems, it was found out that use of following optical films might attain the objects, leading to completion of the present invention.

That is, the present invention relates to an optical film: comprising an optical compensation layer (2) showing refractive index anisotropy satisfying a relationship of nx₂≈ny₂>nz₂, when a direction where an in-plane refractive index gives a maximum is defined as X-axis, a direction perpendicular to X-axis as Y-axis, a thickness direction as Z-axis, and when refractive indexes in each axial direction are defined as nx₂, ny₂ and nz₂, respectively, on one side of a base material film (1) in which each of refractive index differences represented with |nx₁−ny₁|, |nx₁−nz₁| and |nz₁−ny₁| has values of not more than 0.0006, when a direction where a refractive index in a film plane gives maximum is defined as X-axis, a direction perpendicular to X-axis as Y-axis, a thickness direction of the film as Z-axis, and when refractive indexes in each axial direction are defined as nx₁, ny₁ and nz₁, respectively.

In an optical film of the present invention, an optical film each of whose refractive index differences is controlled small is used as a base material film (1) with an optical compensation layer (2) laminated thereon. Each of the refractive index differences of the base material film (1) is preferably 0.0003 or less, and more preferably 0.0001 or less. Thus, since the base material film (1) has small refractive index differences in each direction, birefringence of the protective film, and leakage of light in a direction shifted from an optical axis in a cross-Nicole arrangement of the polarizing plate may be overcome also when the base material film (1) concerned is used as a protective film for a polarizing plate. In liquid crystal displays in VA mode using this polarizing plate, leakage of light caused by birefringence, and leakage of light caused in a crossed Nicole polarizing plate of a conventional liquid crystal cell may be reduced, which allows realization of liquid crystal displays that may have a wide viewing angle in all directions.

In the optical film, a thickness of the optical compensation layer (2) is preferably 10 μm or less, and more preferably 5 μm or less. A thickness exceeding 10 μm has a tendency of causing defects in orientation at the time of forming of the optical compensation layer (2) with liquid crystal materials, which is not preferable. On the other hand, in view of uniformity of layer formed a thickness is 1 μm or more, and preferably 2 μm or more.

In the optical film, the optical compensation layer (2) is preferably formed of a coating of organic materials.

In the optical film, the optical compensation layer (2) is preferably a cholesteric liquid crystal layer.

Besides, the present invention relates to a method for producing the above-mentioned optical film, comprising the steps of: coating a material to form an optical compensation layer (2) showing refractive index anisotropy satisfying a relationship of nx₂≈ny₂>nz₂, when a direction where an in-plane refractive index gives a maximum is defined as X-axis, a direction perpendicular to X-axis as Y-axis, a thickness direction as Z-axis, and when refractive indexes in each axial direction are defined as nx₂, ny₂ and nz₂, respectively, on one side of a base material film (1) in which each of refractive index differences represented with |nx₁−ny₁|, |nx₁−nz₁| and |nz₁−ny₁| has values of 0.0006 or more, when a direction where a refractive index in a film plane gives maximum is defined as X-axis, a direction perpendicular to X-axis as Y-axis, a thickness direction of the film as Z-axis, and when refractive indexes in each axial direction are defined as nx₁, ny₁ and nz₁, respectively; and orienting the optical compensation layer (2).

Besides, the present invention relates to an optical film in which an at least one layer of other optical elements is further laminated to the optical film.

Polarizers may be illustrated as other optical elements. The polarizer is preferably laminated to a base material film (1) side. An optical film having the polarizer laminated thereon is useful as a wide viewing angle polarizing plate that has a function to compensate birefringence in a diagonal direction of a liquid crystal layer in VA mode, and disposition of the wide viewing angle polarizing plate to both sides of a liquid crystal cell may provide a wide viewing angle liquid crystal display in VA mode.

Furthermore, the present invention relates to an image display device having the optical film laminated thereon.

### BRIEF DESCRIPTION OF THE DRAWINGS

FIG. 1 is one embodiment of a sectional view of an optical film of the present invention;

FIG. 2 is one embodiment of a sectional view of an optical film having a polarizer laminated thereon of the present invention;

FIG. 3 is a sectional view of a polarizing plate of Comparative example;

FIG. 4 is a sectional view of a polarizing plate of Comparative example; and

FIG. 5 is a sectional view of a polarizing plate of Comparative example.

Where, 1: Base material film (1), 2: Optical compensation layer (cholesteric liquid crystal layer), 3: Polarizer, 4: Triacetyl cellulose film.

### DETAILED DESCRIPTION OF THE INVENTION

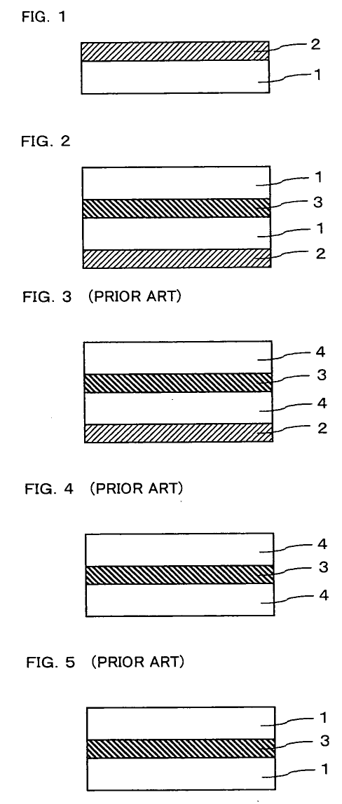

Hereinafter, descriptions will be given with reference to drawings of optical films of the present invention. As shown in FIG. 1, an optical film of the present invention has an optical compensation layer (2) on one side of a base material film (1).

In the base material film (1), each of refractive index differences represented with |nx₁−ny₁|, |nx₁−nz₁| and |nz₁−ny₁| is controlled 0.0006 or less, when a direction where a refractive index in a film plane gives maximum is defined as X-axis, a direction perpendicular to X-axis as Y-axis, a thickness direction of the film as Z-axis, and when refractive indexes in each axial direction are defined as nx₁, ny₁ and nz₁, respectively.

A base material film (1) is not especially limited if it is of a material that satisfies the refractive index difference. For example, there may be used polymer films, such as cyclo-olefin based films, norbornene based films, alicyclic olefin based films, polycarbonate films, polyacrylate based films, polyimide based films, polyester based films, acrylics based films, and polysulfone based films.

In addition, ACRYPLEN etc. manufactured by Mitsubishi Rayon Co., Ltd. may be exemplified as acrylics based resin materials used as acrylics based films. Besides, as thermoplastic saturated norbornene based resins used for norbornene based films, ZEONEX, ZEONOR manufactured by Zeon Corporation, ARTON manufactured by JSR etc. may be exemplified.

Besides, as materials for forming the base material film (1), materials including a thermoplastic resin (A) having a substituted and/or non-substituted imido group in a side chain, and a thermoplastic resin (B) having a substituted and/or non-substituted phenyl group and nitrile group in a side chain may preferably be used. Films including the thermoplastic resins (A) and (B) are described, for example, in WO 01/37007.

The thermoplastic resin (A) may have substituted and/or non-substituted imido group in a side chain, and a principal chain may be of arbitrary thermoplastic resins. The principal chain may be, for example, of a principal chain consisting only of carbon atoms, or otherwise atoms other than carbon atoms may also be inserted between carbon atoms. And it may also comprise atoms other than carbon atoms. The principal chain is preferably of hydrocarbons or of substitution products thereof. The principal chain may be, for example, obtained by an addition polymerization. Among concrete examples are polyolefins and polyvinyls. And the principal chain may also be obtained by a condensation polymerization. It may be obtained by, for example, ester bonds, amido bonds, etc. The principal chain is preferably of polyvinyl skeletons obtained by polymerization of substituted vinyl monomers.

As methods for introducing substituted and/or non-substituted imido group into the thermoplastic resin (A), well-known conventional and arbitrary methods may be employed. As examples for those methods, there may be mentioned a method in which monomers having the above-mentioned imido group are polymerized, a method in which the above-mentioned imido group is introduced after a principal chain is formed by polymerization of various monomers, and a method in which compounds having the above-mentioned imido group is grafted to a side chain. As substituents for imido group, well-known conventional substituents that can substitute a hydrogen atom of the imido group may be used. For example, alkyl groups, etc. may be mentioned as examples.

The thermoplastic resin (A) is preferably of two or more component copolymers including a repeating unit induced from at least one kind of olefin, and a repeating unit having at least one kind of substituted and/or non-substituted maleimido structure. The above-mentioned olefin-maleimido copolymers may be synthesized from olefins and maleimido compounds using well-known methods. The synthetic process is described in, for example, Japanese Patent Laid-Open Publication No.H5-59193, Japanese Patent Laid-Open Publication No.H5-195801, Japanese Patent Laid-Open Publication No.H6-136058, and Japanese Patent Laid-Open Publication No.H9-328523 official gazettes.

As olefins, for example, there may be mentioned, isobutene, 2-methyl-1-butene, 2-methyl-1-pentene, 2-methyl-1-hexene, 2-methyl-1-heptene, 1-iso octene, 2-methyl-1-octene, 2-ethyl-1-pentene, 2-ethyl-2-butene, 2-methyl-2-pentene, and 2-methyl-2-hexene etc. Among them, isobutene is preferable. These olefins may be used independently and two or more kinds may be used in combination.

As maleimido compounds, there may be mentioned, maleimide, N-methyl maleimide, N-ethylmaleimide, N-n-propyl maleimide, N-i-propyl maleimide, N-n-butyl maleimide, N-s-butyl maleimide, N-t-butyl maleimide, N-n-pentyl maleimide, N-n-hexyl maleimide, N-n-heptyl maleimide, N-n-octyl maleimide, N-lauryl maleimide, N-stearyl maleimide, N-cyclo propyl maleimide, N-cyclobutyl maleimide, N-cyclopentyl maleimide, N-cyclohexyl maleimide, N-cycloheptyl maleimide, and N-cyclooctyl maleimide, etc. Among them N-methyl maleimide is preferable. These maleimido compounds may be used independently and two or more kinds may be used in combination.

A content of repeating units of olefin in the olefin-maleimido copolymer is not especially limited, and it is approximately 20 through 70 mole % in all of repeating units in the thermoplastic resin (A), preferably 40 through 60 mole %, and more preferably 45 through 55 mole %. A content of repeating units of maleimido structure is approximately 30 through 80 mole %, preferably 40 through 60 mole %, and more preferably 45 through 55 mole %.

The thermoplastic resin (A) may comprise repeating units of the above-mentioned olefin, and repeating units of maleimido structure, and it may be formed only of these units. And in addition to the above constitution, other vinyl based monomeric repeating units may be included at a percentage of 50 mole % or less. As other vinyl based monomers, there may be mentioned, acrylic acid based monomers, such as methyl acrylate and butyl acrylate; methacrylic acid based monomers, such as methyl methacrylate and cyclo hexyl methacrylate; vinyl ester monomers, such as vinyl acetate; vinyl ether monomers, such as methyl vinyl ether; acid anhydrides, such as maleic anhydride; styrene based monomers, such as styrene, α-methyl styrene, and p-methoxy styrene etc.

A weight average molecular weight of the thermoplastic resin (A) is not especially limited, and it is approximately 1×10³ through 5×10⁶. The above-mentioned weight average molecular weight is preferably 1×10⁴ or more and 5×10⁵ or more. A glass transition temperature of the thermoplastic resin (A) is 80° C. or more, preferably 100° C. or more, and more preferably 130° C. or more.

And glutar imido based thermoplastic resins may be used as the thermoplastic resin (A). Glutar imido based resins are described in Japanese Patent Laid-Open Publication No.H2-153904 etc. Glutar imido based resins have glutar imido structural units and methyl acrylate or methyl methacrylate structural units. The above-mentioned other vinyl based monomers may be introduced also into the glutar imido based resins.

The thermoplastic resin (B) is a thermoplastic resin having substituted and/or non-substituted phenyl group, and nitrile group in a side chain. As a principal chain of the thermoplastic resin (B), similar principal chains as of the thermoplastic resin (A) may be illustrated.

As a method of introducing the above-mentioned phenyl group into the thermoplastic resin (B), for example, there may be mentioned a method in which monomers having the above-mentioned phenyl group is polymerized, a method in which phenyl group is introduced after various monomers are polymerized to form a principal chain, and a method in which compounds having phenyl group are grafted into a side chain, etc. As substituents for phenyl group, well-known conventional substituents that can substitute a hydrogen atom of the phenyl group may be used. For example, alkyl groups, etc. may be mentioned as examples. As method for introducing nitrile groups into the thermoplastic resin (B), similar methods for introducing phenyl groups may be adopted.

The thermoplastic resin (B) is preferably of two or more components copolymers comprising repeating unit (nitrile unit) induced from unsaturated nitrile compounds, and repeating unit (styrene based unit) induced from styrene based compounds. For example, acrylonitrile styrene based copolymers may preferably be used.

As unsaturated nitrile compounds, arbitrary compounds having cyano groups and reactive double bonds may be mentioned. For example, acrylonitrile, α-substituted unsaturated nitrites, such as methacrylonitrile, nitrile compounds having has α- and β-disubstituted olefin based unsaturated bond, such as fumaronitrile may be mentioned.

As styrene based compound, arbitrary compounds having a phenyl group and a reactive double bond may be mentioned. For example, there may be mentioned, non-substituted or substituted styrene based compounds, such as styrene, vinyltoluene, methoxy styrene, and chloro styrene; α-substituted styrene based compounds, such as α-methyl styrene.

A content of a nitrile unit in the thermoplastic resin (B) is not especially limited, and it is approximately 10 through 70% by weight on the basis of all repeating units, preferably 20 through 60% by weight, and more preferably 20 through 50% by weight. It is further preferably 20 through 40% by weight, and still further preferably 20 through 30% by weight. A content of a styrene based unit is approximately 30 through 80% by weight, preferably 40 through 80% by weight, and more preferably 50 through 80% by weight. It is especially 60 through 80% by weight, and further preferably 70 through 80% by weight.

The thermoplastic resin (B) may comprise repeating units of the above-mentioned nitrites, and styrene based repeating units, and it may be formed only of these units. And in addition to the above constitution, other vinyl based monomeric repeating units may be included at a percentage of 50 mole % or less. As other vinyl based monomers, compounds, repeating units of olefins, repeating units of maleimide and substituted maleimides, etc. may be mentioied, which were illustrated in the case of thermoplastic resin (A). As the thermoplastic resins (B), AS resins, ABS resins, ASA resins, etc. may be mentioned.

A weight average molecular weight of the thermoplastic resin (B) is not especially limited, and it is approximately 1×10³ through 5×10⁶. It is preferably 1×10⁴ or more, and 5×10⁵ or less.

A compounding ratio of the thermoplastic resin (A) and the thermoplastic resin (B) is adjusted depending on a retardation required for a transparent protective film. In the above-mentioned compounding ratio, in general, a content of the thermoplastic resin (A) is preferably 50 through 95% by weight in total amount of a resin in a film, more preferably 60 through 95% by weight, and still more preferably 65 through 90% by weight. A content of the thermoplastic resin (B) is preferably 5 through 50% by weight in total amount of the resin in the film, more preferably 5 through 40% by weight, and still more preferably 10 through 35% by weight. The thermoplastic resin (A) and the thermoplastic resin (B) are mixed using a method in which these are kneaded in thermally molten state.

Techniques for producing the base material film (1) are not especially limited. For example, extrusion film-forming method, casting film-forming method, etc. may be applicable. A thickness of the base material film (1) is usually about 20 to 100 μm, and preferably 30 to 60 μm.

In addition, the base material film (1) may also be stretched as long as it satisfies the refractive index difference. In general, stretching of a film material can improve the strength and can realize tougher mechanical property. Although stretching processing gives a retardation in many materials, the base material film (1) including a mixture of the thermoplastic resin (A) and (B) as a principal component can satisfy the above-mentioned refractive index difference, even when stretching processing is given. Any of uniaxial stretching and biaxial stretching is suitable as a stretching processing. Especially films to which biaxial stretching process is given are preferable.

The optical compensation layer (2) shows refractive index anisotropy satisfying a relationship of nx₂≈ny₂>nz₂, when a direction where an in-plane refractive index gives a maximum is defined as X-axis, a direction perpendicular to X-axis as Y-axis, a thickness direction as Z-axis, and when refractive indexes in each axial direction are defined as nx₂, ny₂ and nz₂, respectively. Besides, the optical compensation layer (2) is preferably a thin layer having a thickness of 10 μm or less.

An in-plane retardation: ((nx₂−ny₂)×d₂) (thickness: nm)) of the optical compensation layer (2) is preferably 10 nm or less, and more preferably 5 nm or less. Retardation in a thickness direction ((nx₂−nz₂)×d₂) is preferably 30 to 500 nm, and more preferably 80 to 300 nm.

When handling after forming of the optical compensation layer (2) is taken into consideration, the optical compensation layer (2) showing refractive index anisotropy is preferably formed by coating an organic material onto a base material film (1). Methods of coating are not especially limited, but usual methods may be adopted. For example, a photogravure coating method, a die coating method, a dipping, a roll coating method, a spin coating method, a bar coating method, etc. may be employable.

An optical compensation layer (2) is preferably a cholesteric liquid crystal layer. When an average refractive index of a cholesteric liquid crystal is defined as nc, a helical pitch is defined as P (nm) and a light enters in parallel with a helical axis, a cholesteric liquid crystalline compound causes selective reflection centering on a light wavelength equal to a value of nc×P. In the present invention, in order that such selective reflection may not be given in a visible light area, materials are preferably selected and used so that the value of nc×P may be out of the visible light area. A selective reflection wavelength band of the cholesteric liquid crystal layer is preferably controlled within a range of 100 to 320 nm.

The cholesteric liquid crystal layer is not especially limited, if it is a liquid crystal layer that presents cholesteric liquid crystal phase in a liquid crystal state. Single or two or more of cholesteric liquid crystal layer may be formed. A cholesteric liquid crystal layer may be formed with a liquid crystalline compound and a chiral agent. The chiral agent is included 7% or more by weight to a sum total with the liquid crystalline compound. A helical twisting strength (nm⁻¹·wt %⁻¹) represented by a following formula:
Helical twisting strength=1/{selective reflection wavelength (nm) of cholesteric liquid crystal layer×chiral agent weight ratio (wt %)}
is preferably controlled to be 1×10⁻⁶ (nm⁻¹·wt %⁻¹) or more.

From a viewpoint of optical property and cost, the helical twisting strength is preferably 1×10⁻⁶ (nm⁻¹·wt %⁻¹) or more, more preferably 1×10⁻⁵ (nm⁻¹·wt %⁻¹) or more, and still more preferably 1×10⁴ (nm⁻¹·wt %⁻¹) or more. Besides, a weight of the chiral agent is preferably 7% or more by weight to the liquid crystalline compound, and especially when it is 7.5 to 17% by weight, extremely excellent optical property is shown, which is more preferable.

As methods for forming a cholesteric liquid crystal layer, for example, a method in which a polymerizable liquid crystal monomer is applied, oriented, and then cured and fixed, and a method in which a liquid crystal polymer is applied, oriented, and then fixed may be mentioned.

As the polymerizable liquid crystal monomers, for example, nematic liquid crystalline or smectic liquid crystalline monomer may be mentioned. Cholesteric liquid crystalline monomers and chiral agents are blended to the nematic liquid crystalline monomer etc. so that cholesteric liquid crystal phase may be presented in liquid crystal state.

As the nematic liquid crystalline monomers etc., monomers that have polymerizable functional groups, such as an acryloyl group and a methacryloyl group as a terminal group, and further have mesogen groups comprising cyclic unit etc. may be mentioned. Besides, cross-linked structures may be introduced using monomers having two or more of acryloyl groups or methacryloyl groups, etc. as polymerizable functional groups, to improve durability of the products. As the cyclic unit used as mesogen groups, there may be mentioned, for example: biphenyl based, phenyl benzoate based, phenyl cyclohexane based, azoxy benzene based, azomethine based, azobenzene based, phenyl pyrimidine based, diphenyl acetylene based, diphenyl benzoate based, bicyclo hexane based, cyclo hexyl benzene based, terphenyl based units, etc. In addition, an end group of these cyclic units may have substituted groups, such as a cyano group, an alkyl group, an alkoxy group, and a halogen group.

Chiral agents are not especially limited, as long as they have optical activity groups and do not disturb orientation of, such as nematic liquid crystalline monomers. Although chiral agents may or may not have liquid crystallinity, chiral agents showing cholesteric liquid crystallinity may preferably be used. Although both of chiral agents that have reactive groups or that do not have reactive groups may be used, chiral agents having reactive groups are preferable in view of heat resistance and solvent resistance of the cholesteric liquid crystal orientation film obtained by being cured. As reactive groups, acryloyl groups, methacryloyl groups, azido groups, epoxy groups, etc. may be mentioned.

In addition, when polymerizable liquid crystal monomers are used for forming of the cholesteric liquid crystal layer, photo polymerization initiators are usually used. Various kinds of photo polymerization initiators may be used without any limitation. As a photo polymerization initiator, for example, Irgacure 907, Irgacure 184, Irgacure 651, Irgacure 369, etc. manufactured by CHIBA SPECIALITY CHEMICALS may be illustrated. Photo polymerization initiators are added in a grade not disturbing orientation property of a thermotropic liquid crystalline compound. Usually, it is preferably about 0.5 to 30 parts by weight to the polymerizable liquid crystal monomer 100 parts by weight, and more preferably 3 to 15 parts by weight.

As the liquid crystal polymer, for example, liquid crystal polymers, which have various skeletons of principal chain type and side chain type or compound type thereof, showing cholesteric liquid crystal orientation, may be used. The liquid crystal polymers may be prepared by introducing chiral components into liquid crystal polymers so that a cholesteric liquid crystal phase may be presented in a liquid crystal state. Besides, chiral agents may be included using nematic based liquid crystal polymers as a liquid crystal polymer so that a cholesteric liquid crystal phase may be presented in a liquid crystal state.

As principal chain type liquid crystal polymers, polymers of condensation based polymer having a structure with a mesogen group comprising aromatic series units bonded thereto etc., for example, polymers, such as polyester based, polyamide based, polycarbonate based and polyester imido based polymers may be mentioned. As the aromatic series unit giving mesogen groups, phenyl based, biphenyl based, and naphthalene based units may be mentioned, and the aromatic based units may have substituted groups, such as a cyano group, an alkyl group, an alkoxy group and a halogen group.

As side chain type liquid crystal polymers, polymers that have a polyacrylate based, poly methacrylate based, polysiloxane based, and poly malonate based principal chain as a skeleton, and that have mesogen groups comprising cyclic units etc. in side chains may be mentioned. As the cyclic unit giving mesogen groups, for example, biphenyl based, phenyl benzoate based, phenyl cyclohexane based, azoxy benzene based, azomethine based, azobenzene based, phenyl pyrimidine based, diphenyl acetylene based, biphenyl benzoate based, bicyclo hexane based, cyclo hexyl benzene based, terphenyl based units etc. may be mentioned. In addition, end groups of these cyclic units may have substituted groups, such as a cyano group, an alkyl group, an alkoxy group, and a halogen group.

Any of mesogen groups of the polymerizable liquid crystal monomer and the liquid crystal polymer may be bonded through spacer parts giving flexibility. As spacer parts, poly methylene chain, polyoxymethylene chain, etc. may be mentioned. A number of repetitions of structure units forming the spacer parts is suitably determined based on chemical structures of the mesogen part, and a number of repeating units of poly methylene chain is 0 to 20, preferably 2 to 12, and a number of repeating units of the polyoxy methylene chain is 0 to 10, and preferably 1 to 3.

A molecular weight of the liquid crystal polymer is not especially limited, but a weight average molecular weight is preferably approximately 2,000 to 100,000. Large weight average molecular weights of the liquid crystal polymer decrease orientation as a liquid crystal, and as a result a tendency for formation of uniform orientation state of the liquid crystal polymer to become difficult is shown. Therefore, a weight average molecular weight of the liquid crystal polymer is more preferably 50,000 or less. Besides, since a tendency is shown for small weight average molecular weights of the liquid crystal polymer to reduce film forming property as a non-fluidized layer, a weight average molecular weight of the liquid crystal polymer is more preferably 2,500 or more.

Development of the liquid crystalline compound (polymerizable liquid crystal monomer and cholesteric liquid crystal polymer) may be performed by a heating melting method, and also be performed by a solution method using solvents. As solvents usually, there may be used: halogenated hydrocarbons, such as chloroform, dichloromethane, dichloroethane, tetrachloroethane, trichloroethylene, tetrachloroethylene, and chlorobenzene; phenols, such as phenol and parachlorophenol; aromatic hydrocarbons, such as benzene, toluene, xylene, methoxy benzene, 1,2-dimethoxy benzene; and furthermore, acetone, ethyl acetate, tert-butyl alcohol, glycerin, ethylene glycol, triethylene glycol, ethylene glycol monmethyl ether, diethylene glycol dimethyl ether, ethyl cellosolve, butyl cellosolve, 2-pyrrolidone, N-methyl-2-pyrrolidone, pyridine, triethyl amine, tetrahydrofuran, dimethyl formamide, dimethyl acetamide, dimethyl sulfoxide, acetonitrile, butyronitrile, carbon disulfide, cyclohexanone, etc. Although concentrations of solutions may not simply be determined since they are dependent on solubility of the liquid crystalline compounds, or film thickness of the cholesteric liquid crystal layers, they are usually in a range of 3 to 50% by weight, and preferably 7 to 30% by weight. Solvents are removed after coating of a solution and a liquid crystal layer is formed on a substrate. Conditions of removing the solvents are not especially limited, and any conditions may be adopted if the solvents are removed in general, and if the liquid crystal polymer layer or the liquid crystalline compound layer does not flow around or does not flow off. Usually, methods such as drying at room temperature, drying in a drying furnace, and heating on a hot plate may be adopted to remove the solvent.

As coating methods of the liquid crystalline compound, the above-mentioned method may be adopted. Orientation processing is usually given to a base material for forming cholesteric liquid crystal layers. As orientation base materials, conventionally known materials are employable. For example, there may be used: a rubbed film in which a thin film comprising polyimides, polyvinyl alcohols, etc. is formed on a substrate, then rubbing treatment with a rayon cloth etc., is given to the thin film; a rhombic deposition film; an optical alignment layer of a polymer having optical cross-linking groups, such as cinnamate and azobenzene, or of a polyimide, irradiated with polarized ultraviolet rays; and a stretched film. In addition, orientation can also be given by methods using magnetic field, electric field orientation, and shearing stress operation. Moreover, use of a stretched film as an orientation base material does not require orientation processing, but may simplify producing processes. As stretched films, for example, stretched polyethylene terephthalate films etc. may be illustrated.

Subsequently, a liquid crystal layer formed on the base material film (1) is get into a liquid crystal state, and cholesteric orientation is then given. For example, heat treating is performed so that the liquid crystal layer may be in a liquid crystal temperature range. The heat treating method may be performed by same methods as in the above-mentioned drying methods. Since heat treating temperatures may vary according to types of liquid crystalline compounds, it may not be simply determined, and it is usually 60 to 300° C., and preferably in a range of 70 to 200° C. Moreover, since heat treating period may vary according to heat treating temperatures and types of liquid crystalline compounds to be used, it may not be simply determined, and it is usually in a range of 10 seconds to 2 hours, and preferably in a range of 20 seconds to 30 minutes.

After termination of heat treating, cooling operation is performed and orientation is thus fixed. Taking out the cholesteric liquid crystal layer performs the cooling operation after the heat treating into a room temperature out of heated atmosphere of the heat treating operation. Besides, a forced cooling, such as air-cooling and water-cooling, may also be performed. In the cholesteric liquid crystal layer, orientation is fixed by being cooled glass transition temperatures or less of the liquid crystalline compounds.

When polymerizable liquid crystal monomers are included as liquid crystalline compounds, optical irradiation is given to a thus fixed cholesteric liquid crystal layer for polymerization of cross-linking of the photopolymerizable liquid crystalline compound to fix the photopolymerizable liquid crystalline compound, obtaining a cholesteric liquid crystal layer having improved durability. Optical irradiation is performed by, for example, ultraviolet rays irradiation. Conditions for ultraviolet rays irradiation are preferably set within an inert gas atmosphere in order to fully promote the reaction. Usually here, a high voltage mercury ultraviolet rays lamp with an intensity of illumination of approximately 80 to 160 mW/cm² is typically used. Another kind lamps, such as a meta halide UV lamp and an incandescent tube, may also be used. In addition, liquid layer surface temperatures at the time of ultraviolet irradiation may suitably be adjusted using cooling processing, such as a cold mirror, a water cooling and others or a higher line velocity so that the layer surface temperatures may be within a range of liquid crystal temperatures.

In an optical film of the present invention, an optical compensation layers (2), such as a cholesteric liquid crystal layer, may be formed, using the base material film (1) as a base material. Besides, it can also be produced by transferring an optical compensation layer (2) formed on another film onto the base material film (1).

Various kinds of optical elements may be laminated on the optical film. A number of laminating and laminating position of various optical elements are not especially limited. FIG. 2 shows a broadband polarizing plate in which a polarizer (3) is laminated on a side of a base material film (1) of the optical film. In FIG. 2, a base material film (1) is further laminated on a polarizer (3) as a protective film. As a protective film further laminated on a polarizer (3), protective films usually used other than the base material film (1) may also be utilized.

A polarizing plate (3) is not limited especially but various kinds of polarizer may be used. As a polarizer, for example, a film that is uniaxially stretched after having dichromatic substances, such as iodine and dichromatic dye, absorbed to hydrophilic high molecular weight polymer films, such as polyvinyl alcohol type film, partially formalized polyvinyl alcohol type film, and ethylene-vinyl acetate copolymer type partially saponified film; poly-ene type orientation films, such as dehydrated polyvinyl alcohol and dehydrochlorinated polyvinyl chloride, etc. may be mentioned. In these, a polyvinyl alcohol type film on which dichromatic materials (iodine, dyes) is absorbed and oriented after stretched is suitably used. Although thickness of polarizer is not especially limited, the thickness of about 5 to 80 μm is commonly adopted.

A polarizer that is uniaxially stretched after a polyvinyl alcohol type film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol type film may be dipped in water and rinsed if needed. By rinsing polyvinyl alcohol type film with water, effect of preventing un-uniformity, such as unevenness of dyeing, is expected by making polyvinyl alcohol type film swelled in addition that also soils and blocking inhibitors on the polyvinyl alcohol type film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

As the transparent protective film prepared on one side or both sides of the polarizer, materials is excellent in transparency, mechanical strength, heat stability, water shielding property, isotropy, etc. may be preferably used. As materials of the above-mentioned protective layer, for example, polyester type polymers, such as polyethylene terephthalate and polyethylenenaphthalate; cellulose type polymers, such as diacetyl cellulose and triacetyl cellulose; acrylics type polymer, such as poly methylmethacrylate; styrene type polymers, such as polystyrene and acrylonitrile-styrene copolymer (AS resin); polycarbonate type polymer may be mentioned. Besides, as examples of the polymer forming a protective film, polyolefin type polymers, such as polyethylene, polypropylene, polyolefin that has cyclo-type or norbornene structure, ethylene-propylene copolymer; vinyl chloride type polymer; amide type polymers, such as nylon and aromatic polyamide; imide type polymers; sulfone type polymers; polyether sulfone type polymers; polyether-ether ketone type polymers; poly phenylene sulfide type polymers; vinyl alcohol type polymer; vinylidene chloride type polymers; vinyl butyral type polymers; allylate type polymers; polyoxymethylene type polymers; epoxy type polymers; or blend polymers of the above-mentioned polymers may be mentioned. Films made of heat curing type or ultraviolet ray curing type resins, such as acryl based, urethane based, acryl urethane based, epoxy based, and silicone based, etc. may be mentioned.

Moreover, as is described in Japanese Patent Laid-Open Publication No. 2001-343529 (WO 01/37007), polymer films, for example, resin compositions including (A) thermoplastic resins having substituted and/or non-substituted imido group is in side chain, and (B) thermoplastic resins having substituted and/or non-substituted phenyl and nitrile group in sidechain may be mentioned. As an illustrative example, a film may be mentioned that is made of a resin composition including alternating copolymer comprising iso-butylene and N-methyl maleimide, and acrylonitrile-styrene copolymer. A film comprising mixture extruded article of resin compositions etc. may be used.

As a transparent protective film preferably used, in viewpoint of polarization property and durability, triacetyl cellulose film whose surface is saponificated with alkali is suitable. In general, a thickness of a transparent protective film is about 10 through 500 μm, preferably 20 through 300 μm, and especially preferably 30 through 200 μm.

Moreover, it is preferable that the transparent protective film may have as little coloring as possible. Accordingly, a protective film having a phase difference value in a film thickness direction represented by Rth=[(nx+ny)/2−nz]×d of −90 nm through +75 nm (where, nx and ny represent principal indices of refraction in a film plane, nz represents refractive index in a film thickness direction, and d represents a film thickness) may be preferably used. Thus, coloring (optical coloring) of polarizing plate resulting from a protective film may mostly be cancelled using a protective film having a phase difference value (Rth) of −90 nm through +75 nm in a thickness direction. The phase difference value (Rth) in a thickness direction is preferably −80 nm through +60 nm, and especially preferably −70 nm through +45 nm.

As a transparent protective film, if polarization property and durability are taken into consideration, cellulose based polymer, such as triacetyl cellulose, is preferable, and especially triacetyl cellulose film is suitable. In addition, when transparent protective films are provided on both sides of the polarizer, transparent protective films comprising same polymer material may be used on both of a front side and a back side, and transparent protective films comprising different polymer materials etc. may be used.

Adhesives are used for adhesion processing of the above described polarizer and the transparent protective film. As adhesives, polyvinyl alcohol derived adhesives, gelatin derived adhesives, vinyl polymers derived latex type, aqueous polyurethane based adhesives, aqueous polyesters derived adhesives, etc. may be mentioned.

A hard coat layer may be prepared, or antireflection processing, processing aiming at sticking prevention, diffusion or anti glare may be performed onto the face on which the polarizing film of the above described transparent protective film has not been adhered.

A hard coat processing is applied for the purpose of protecting the surface of the polarizing plate from damage, and this hard coat film may be formed by a method in which, for example, a curable coated film with excellent hardness, slide property etc. is added on the surface of the protective film using suitable ultraviolet curable type resins, such as acrylic type and silicone type resins. Antireflection processing is applied for the purpose of antireflection of outdoor daylight on the surface of a polarizing plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarizing plate to disturb visual recognition of transmitting light through the polarizing plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linked polymers may be used. When forming fine concavo-convex structure on the surface, the amount of fine particle used is usually about 2 to 50 weight part to the transparent resin 100 weight part that forms the fine concavo-convex structure on the surface, and preferably 5 to 25 weight part. An anti glare layer may serve as a diffusion layer (viewing angle expanding function etc.) for diffusing transmitting light through the polarizing plate and expanding a viewing angle etc.

In addition, the above-mentioned antireflection layer, sticking prevention layer, diffusion layer, anti glare layer, etc. may be built in the protective film itself, and also they may be prepared as an optical layer different from the protective layer.

Pressure sensitive adhesive layers may be provided on the optical film. Besides, also when laminating other optical elements, the pressure sensitive adhesive layers may be utilized. In an optical film of FIG. 2, it is preferable to laminate a pressure sensitive adhesive layer onto the optical compensation layer (2) side. In addition, the pressure sensitive adhesive layer(s) in a form of single layer or two or more superimposed layers may be used.

As pressure sensitive adhesive that forms adhesive layer (a) is not especially limited, and, for example, acrylic type polymers; silicone type polymers; polyesters, polyurethanes, polyamides, polyethers; fluorine type and rubber type polymers may be suitably selected as a base polymer. Especially, a pressure sensitive adhesive such as acrylics type pressure sensitive adhesives may be preferably used, which is excellent in optical transparency, showing adhesion characteristics with moderate wettability, cohesiveness and adhesive property and has outstanding weather resistance, heat resistance, etc.

Proper method may be carried out to attach an adhesive layer to one side or both sides of the optical film. As an example, about 10 to 40 weight % of the pressure sensitive adhesive solution in which a base polymer or its composition is dissolved or dispersed, for example, toluene or ethyl acetate or a mixed solvent of these two solvents is prepared. A method in which this solution is directly applied on a polarizing plate top or an optical film top using suitable developing methods, such as flow method and coating method, or a method in which an adhesive layer is once formed on a separator, as mentioned above, and is then transferred on a polarizing plate or an optical film may be mentioned.

The adhesive layer may contain additives, for example, such as natural or synthetic resins, adhesive resins, glass fibers, glass beads, metal powder, fillers comprising other inorganic powder etc., pigments, colorants and antioxidants. Moreover, it may be an adhesive layer that contains fine particle and shows optical diffusion nature.

Thickness of an adhesive layer may be suitably determined depending on a purpose of usage or adhesive strength, etc., and generally is 1 to 500 μm, preferably 5 to 200 μm, and more preferably 10 to 100 μm.

A temporary separator is attached to an exposed side of an adhesive layer to prevent contamination etc., until it is practically used. Thereby, it can be prevented that foreign matter contacts adhesive layer in usual handling. As a separator, without taking the above-mentioned thickness conditions into consideration, for example, suitable conventional sheet materials that is coated, if necessary, with release agents, such as silicone type, long chain alkyl type, fluorine type release agents, and molybdenum sulfide may be used. As a suitable sheet material, plastics films, rubber sheets, papers, cloths, no woven fabrics, nets, foamed sheets and metallic foils or laminated sheets thereof may be used.

In addition, in the present invention, ultraviolet absorbing property may be given to the above-mentioned each layer, such as a polarizer for a polarizing plate, a transparent protective film and an optical film etc. and an adhesive layer, using a method of adding UV absorbents, such as salicylic acid ester type compounds, benzophenol type compounds, benzotriazol type compounds, cyano acrylate type compounds, and nickel complex salt type compounds.

The above-mentioned broadband polarizing plate is useful in liquid crystal displays in VA mode, which is disposed on both sides of a liquid crystal cell in VA mode so that the optical compensation layer (2) may be disposed on a liquid crystal cell substrate side, and thereby a liquid crystal display having a wide viewing angle may be obtained. A liquid crystal cell in VA mode includes two substrates sandwiching a liquid crystal layer and a liquid crystal molecules that are to be oriented in an approximately vertical direction to the substrate in a non-driven state in which an external electric field is not applied with respect to the liquid crystal layer. The above-mentioned broadband polarizing plate is laminated so that the optical compensation layer (2) may be disposed on a substrate side of the liquid crystal cell and absorption axes of each polarizing plate may mutually intersect perpendicularly.

In an optical film of the present invention, other optical layers may further be laminated. Besides, a liquid crystal display in the above-mentioned VA mode represents only an example of the liquid crystal cell, the liquid crystal may be used for various kinds of liquid crystal displays.

A reflective layer is prepared on a polarizing plate to give a reflection type polarizing plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarizing plate may be formed using suitable methods, such as a method in which a reflective layer of metal etc. is, if required, attached to one side of a polarizing plate through a protective layer etc.

As an example of a reflection type polarizing plate, a plate may be mentioned on which, if required, a reflective layer is formed using a method of attaching a foil and vapor deposition film of reflective metals, such as aluminum, to one side of a matte treated protective film.

Instead of a method in which a reflection plate is directly given to the protective film of the above-mentioned polarizing plate, a reflection plate may also be used as a reflective sheet constituted by preparing a reflective layer on the suitable film for the transparent film. In addition, since a reflective layer is usually made of metal, it is desirable that the reflective side is covered with a protective film or a polarizing plate etc. when used, from a viewpoint of preventing deterioration in reflectance by oxidation, of maintaining an initial reflectance for a long period of time and of avoiding preparation of a protective layer separately etc.

In addition, a transreflective type polarizing plate may be obtained by preparing the above-mentioned reflective layer as a transreflective type reflective layer, such as a half-mirror etc. that reflects and transmits light. A transreflective type polarizing plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transreflective type polarizing plate. That is, the transreflective type polarizing plate is useful to obtain of a liquid crystal display of the type that saves energy of light sources, such as a back light, in a well-lighted atmosphere, and can be used with a built-in light source if needed in a comparatively dark atmosphere etc.

The polarizing plate with which a polarizing plate and a brightness enhancement film are adhered together is usually used being prepared in a backside of a liquid crystal cell. A brightness enhancement film shows a characteristic that reflects linearly polarized light with a predetermined polarization axis, or circularly polarized light with a predetermined direction, and that transmits other light, when natural light by back lights of a liquid crystal display or by reflection from a back-side etc., comes in. The polarizing plate, which is obtained by laminating a brightness enhancement film to a polarizing plate, thus does not transmit light without the predetermined polarization state and reflects it, while obtaining transmitted light with the predetermined polarization state by accepting a light from light sources, such as a backlight. This polarizing plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarizing plate simultaneously supplies polarized light that is difficult to be absorbed in a polarizer, and increases the quantity of the light usable for a liquid crystal picture display etc., and as a result luminosity may be improved. That is, in the case where the light enters through a polarizer from backside of a liquid crystal cell by the back light etc. without using a brightness enhancement film, most of the light, with a polarization direction different from the polarization axis of a polarizer, is absorbed by the polarizer, and does not transmit through the polarizer. This means that although influenced with the characteristics of the polarizer used, about 50 percent of light is absorbed by the polarizer, the quantity of the light usable for a liquid crystal picture display etc. decreases so much, and a resulting picture displayed becomes dark. A brightness enhancement film does not enter the light with the polarizing direction absorbed by the polarizer into the polarizer but reflects the light once by the brightness enhancement film, and further makes the light reversed through the reflective layer etc. prepared in the backside to re-enter the light into the brightness enhancement film. By this above-mentioned repeated operation, only when the polarization direction of the light reflected and reversed between the both becomes to have the polarization direction which may pass a polarizer, the brightness enhancement film transmits the light to supply it to the polarizer. As a result, the light from a backlight may be efficiently used for the display of the picture of a liquid crystal display to obtain a bright screen.

A diffusion plate may also be prepared between brightness enhancement film and the above described reflective layer, etc. A polarized light reflected by the brightness enhancement film goes to the above described reflective layer etc., and the diffusion plate installed diffuses passing light uniformly and changes the light state into depolarization at the same time. That is, the diffusion plate returns polarized light to natural light state. Steps are repeated where light, in the unpolarized state, i.e., natural light state, reflects through reflective layer and the like, and again goes into brightness enhancement film through diffusion plate toward reflective layer and the like. Diffusion plate that returns polarized light to the natural light state is installed between brightness enhancement film and the above described reflective layer, and the like, in this way, and thus a uniform and bright screen may be provided while maintaining brightness of display screen, and simultaneously controlling non-uniformity of brightness of the display screen. By preparing such diffusion plate, it is considered that number of repetition times of reflection of a first incident light increases with sufficient degree to provide uniform and bright display screen conjointly with diffusion function of the diffusion plate.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film having a different refractive-index anisotropy; an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported; etc. may be mentioned.

Therefore, in the brightness enhancement film of a type that transmits a linearly polarized light having the above-mentioned predetermined polarization axis, by arranging the polarization axis of the transmitted light and entering the light into a polarizing plate as it is, the absorption loss by the polarizing plate is controlled and the polarized light can be transmitted efficiently. On the other hand, in the brightness enhancement film of a type that transmits a circularly polarized light as a cholesteric liquid-crystal layer, the light may be entered into a polarizer as it is, but it is desirable to enter the light into a polarizer after changing the circularly polarized light to a linearly polarized light through a retardation plate, taking control an absorption loss into consideration. In addition, a circularly polarized light is convertible into a linearly polarized light using a quarter wavelength plate as the retardation plate.

A retardation plate that works as a quarter wavelength plate in a wide wavelength ranges, such as a visible-light band, is obtained by a method in which a retardation layer working as a quarter wavelength plate to a pale color light with a wavelength of 550 nm is laminated with a retardation layer having other retardation characteristics, such as a retardation layer working as a half-wavelength plate. Therefore, the retardation plate located between a polarizing plate and a brightness enhancement film may consist of one or more retardation layers.

In addition, also in a cholesteric liquid-crystal layer, a layer reflecting a circularly polarized light in a wide wavelength ranges, such as a visible-light band, may be obtained by adopting a configuration structure in which two or more layers with different reflective wavelength are laminated together. Thus a transmitted circularly polarized light in a wide wavelength range may be obtained using this type of cholesteric liquid-crystal layer.

Moreover, the polarizing plate may consist of multi-layered film of laminated layers of a polarizing plate and two of more of optical layers as the above-mentioned separated type polarizing plate. Therefore, a polarizing plate may be a reflection type elliptically polarizing plate or a semi-transmission type elliptically polarizing plate, etc. in which the above-mentioned reflection type polarizing plate or a transflective type polarizing plate is combined with above described retardation plate respectively.

Assembling of a liquid crystal display may be carried out according to conventional methods. That is, a liquid crystal display is generally manufactured by suitably assembling several parts such as a liquid crystal cell, optical films and, if necessity, lighting system, and by incorporating driving circuit. In the present invention, except that an elliptically polarizing plate by the present invention is used, there is especially no limitation to use any conventional methods. Also any liquid crystal cell of arbitrary type, such as TN type, and STN type, π type may be used.

Suitable liquid crystal displays, such as liquid crystal display with which the above-mentioned elliptically polarizing plate has been located at one side or both sides of the liquid crystal cell, and with which a backlight or a reflector is used for a lighting system may be manufactured. In this case, the optical film by the present invention may be installed in one side or both sides of the liquid crystal cell. When installing the optical films in both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

### EXAMPLE

Hereinafter, detailed descriptions for embodiments of the present invention will be given, with reference to Examples, but the present invention is not to be limited by these Examples.

In addition, refractive indexes nx, ny, and nz of each film were obtained by measuring characteristics in λ=590 nm using an automatic birefringence measuring equipment (manufactured by Oji Scientific Instruments KOBRA21ADH).

### Example 1

An acrylics based resin material (ACRYPLEN, manufactured by Mitsubishi Rayon Co., Ltd.) 30% by weight of toluene solution was prepared, which was cast to manufacture a base material film (1-1) with a thickness of 50 μm. Each refractive index differences of |nx₁−ny₁|, |nx₁−nz₁| and |nz₁−ny₁| of this base material film (1-1) gave 0.0001.

Polyvinyl alcohol was coated to one side of the base material film (1-1), and orientation processing by rubbing was given to form an alignment layer. Subsequently, a liquid crystal material (CB-15, manufactured by Dainippon Ink & Chemicals, Inc.) was coated to the obtained alignment layer. After being heated for 3 minutes at 90° C., it was cooled and fixed in a cholesteric phase state, thereby obtaining an optical film having a cholesteric liquid crystal layer (2) with a thickness of 5 μm currently formed thereon. An in-plane retardation of the resulting cholesteric liquid crystal layer (2) gave 1 nm, and retardation in a thickness direction gave 120 nm.

A side of the base material film (1-1) of this optical film was attached on one side of a film (polarizer (3)) obtained by making iodine absorbed to a polyvinyl alcohol based film and then stretching using a polyvinyl alcohol based pressure sensitive adhesive. The above-mentioned base material film (1-1) was similarly attached on an opposite surface of the polarizer (3) to manufacture a polarizing plate. FIG. 2 shows the obtained polarizing plate.

This polarizing plate was attached on both sides of the liquid crystal cell in VA mode through an acrylic based pressure sensitive adhesive layers (23 μm in thickness) so that the cholesteric liquid crystal layer (2) side might be disposed at substrate side of the liquid crystal cell to obtain a liquid crystal display. Here, attachment was performed so that absorption axes of the polarizing plates might mutually intersect perpendicularly. In this liquid crystal display, when a contrast ratio in an inclination direction of 70 degrees from a normal was measured in a direction making 45 degrees to optical axes of the polarizing plates that mutually intersects perpendicularly, the contrast ratio gave 10. Determination of contrast ratio was performed using EZ Contrast (made by ELDIM SA).

### Example 2

A thermoplastic saturated norbornene based resin (manufactured by JSR, Arton) was dissolved in methylene chloride, subsequently the solution obtained was cast, and a base material film (1-2) with a thickness of 40 μm was manufactured. A refractive index difference of |nx₁−ny₁| of this base material film (1-3) gave 0.000125, a refractive index difference of |nx₁−nz₁| gave 0.000375 and a refractive index difference of |nz₁−ny₁| gave 0.00025.

Except for having used the base material film (1-2) instead of the base material film (1-1) in Example 1, a same method as in Example 1 was repeated, and a cholesteric liquid crystal layer (2) was formed to obtain an optical film. Besides, a same method as in Example 1 was repeated to manufacture a polarizing plate. Moreover, a liquid crystal display in VA mode was produced using a same method as in Example 1 using the polarizing plate. When a contrast ratio was measured using a same method as in Example 1, a contrast ratio gave 9.

### Example 3

A glutar imido copolymer, comprising N-methyl glutar imide and methyl methacrylate (N-methyl glutar imide content 75% by weight, acid content not more than 0.01 mm equivalent/g, glass transition temperature 147° C.), 65 parts by weight, and an acrylonitrile-styrene copolymer, having an acrylonitrile content 28% by weight and a styrene content 72% by weight, 35 parts by weight were melt and kneaded to obtain a resin composition. Thus obtained resin composition was supplied to a T die melt extruder, and a firm with a thickness of 135 μm was obtained. After this film was stretched 1.7 times at 160° C. in a direction of MD, it was stretched 1.8 times at 160° C. in a direction of TD, and thereby a base material film (1-3) with a thickness of 55 μm was manufactured. A refractive index difference of |nx₁−ny₁| of this base material film (1-3) gave 0, a refractive index difference of |nx₁−nz₁| gave 0.00004 and a refractive index difference of |nz₁−ny₁| gave 0.00004.

Except for having used the base material film (1-3) instead of the base material film (1-1) in Example 1, a same method as in Example 1 was repeated, and a cholesteric liquid crystal layer (2) was formed to obtain an optical film. Besides, a same method as in Example 1 was repeated to manufacture a polarizing plate. And, a liquid crystal display in VA mode was produced using a same method as in Example 1 using the polarizing plate. When a contrast ratio was measured using a same method as in Example 1, a contrast ratio gave 12.

### Comparative Example 1

A triacetyl cellulose film with a thickness of 40 μm was used as a base material film (4). Each refractive index differences of |nx₁−ny₁|, |nx₁−nz₁| and |nz₁−ny₁| of this base material film (4) gave 0.001.

Except for having used the base material film (4) instead of the base material film (1-3) in Example 1, a same method as in Example 1 was repeated, and a cholesteric liquid crystal layer (2) was formed to obtain an optical film. Moreover, a same method as in Example 1 was repeated, and a polarizing plate was manufactured. FIG. 3 shows the obtained polarizing plate. And, a liquid crystal display in VA mode was produced using a same method as in Example 1 using the polarizing plate. When a contrast ratio was measured using a same method as in Example 1, a contrast ratio gave 6.

### Comparative Example 2

The base material films (4) were attached on both sides of the polarizer (3), and a polarizing plate was manufactured. FIG. 4 shows the obtained polarizing plate. And, a liquid crystal display in VA mode was produced using a same method as in Example 1 using the polarizing plate. When a contrast ratio was measured using a same method as in Example 1, a contrast ratio gave 2.

### Comparative Example 3

The base material films (1-3) were attached on both sides of polarizer (3), and a polarizing plate was manufactured. FIG. 5 shows the obtained polarizing plate. And, a liquid crystal display in VA mode was produced using a same method as in Example 1 using the polarizing plate. When a contrast ratio was measured using a same method as in Example 1, a contrast ratio gave 4.

1. An optical film: comprising
an optical compensation layer (2) showing refractive index anisotropy satisfying a relationship of nx₂≈ny₂>nz₂,
when a direction where an in-plane refractive index gives a maximum is defined as X-axis, a direction perpendicular to X-axis as Y-axis, a thickness direction as Z-axis, and when refractive indexes in each axial direction are defined as nx₂, ny₂ and nz₂, respectively,
on one side of a base material film (1) in which each of refractive index differences represented with |nx₁−ny₁|, |nx₁−nz₁| and |nz₁−ny₁| has values of 0.0006 or less, respectively,
when a direction where a refractive index in a film plane gives maximum is defined as X-axis, a direction perpendicular to X-axis as Y-axis, a thickness direction of the film as Z-axis, and when refractive indexes in each axial direction are defined as nx₁, ny₁, and nz₁ respectively.

2. The optical film according to claim 1, wherein a thickness of the optical compensation layer (2) is 10 μm or less.

3. The optical film according to claim 1, wherein the optical compensation layer (2) is formed of a coating of an organic material.

4. The optical film according to claim 1, wherein the optical compensation layer (2) is a cholesteric liquid crystal layer.

5. A method for producing the optical film according to claim 1, comprising the steps of:
coating a material to form an optical compensation layer (2) showing refractive index anisotropy satisfying a relationship of nx₂≈ny₂>nz₂, when a direction where an in-plane refractive index gives a maximum is defined as X-axis, a direction perpendicular to X-axis as Y-axis, a thickness direction as Z-axis, and when refractive indexes in each axial direction are defined as nx₂, ny₂ and nz₂, respectively, on one side of a base material film (1) in which each of refractive index differences represented with |nx₁−ny₁|, |nx₁−nz₁|, and |nz₁−ny₁| has values of 0.0006 or less, respectively, when a direction where a refractive index in a film plane gives a maximum is defined as X-axis, a direction perpendicular to X-axis as Y-axis, a thickness direction of the film as Z-axis, and when refractive indexes in each axial direction are defined as nx₁, ny₁, and nz₁ respectively; and
orienting the optical compensation layer (2).

6. The method for producing the optical film according to claim 5, wherein a thickness of the optical compensation layer (2) is 10 μm or less.

7. The method for producing the optical film according to claim 5, wherein the optical compensation layer (2) is formed of a coating of an organic material.

8. The method for producing the optical film according to claim 5, wherein the optical compensation layer (2) is a cholesteric liquid crystal layer.

9. An optical film comprising an at least one layer of other optical element further laminated onto the optical film according to claim 1.

10. The optical film according to claim 9, wherein the other optical element is a polarizer, and the polarizer is laminated on a base material film (1) side.

11. An image display, wherein the optical film according to claim 1 or claim 9 is laminated thereon.
